(19) United States
(12) Patent Application Publication
(10) Pub. No.: US 2019/0210591 A1
(43) Pub. Date: Jul. 11, 2019

(54) System and Method to Enhance the Driving Performance of a Leanable Vehicle

(71) Applicants: SRI INTERNATIONAL, Menlo Park, CA (US); Yamaha Hatsudoki Kabushiki Kaisha, Iwata (JP)

(72) Inventors: Thomas Low, Belmont, CA (US); Bruce Knoth, San Carlos, CA (US); Brian Foster, San Carlos, CA (US); Huihua Zhao, Sunnyvale, CA (US); Martin Gaudreault, San Jose, CA (US)

(21) Appl. No.: 16/240,505

(22) Filed: Jan. 4, 2019

Related U.S. Application Data
(60) Provisional application No. 62/615,005, filed on Jan. 8, 2018.

(51) Int. Cl. B60W 30/02; B60W 40/09; B60W 50/10

(52) U.S. Cl. CPC B60W 30/025; B60W 40/09; B60W 50/10; B60W 2300/36; B60W 2520/105; B60W 2520/06; B60W 2710/0605; B60W 2510/202; B60W 2710/02; B60W 2710/10; B60W 2710/18; B60W 2710/20; B60W 2540/18

(57) ABSTRACT

Systems and methods are provided to enhance the driving performance of a leanable vehicle such as a motorcycle. The system includes a leanable vehicle interface to receive input from a driver (e.g., a human or a robotic driver) and a sensor interface to receive inputs from sensors on the leanable vehicle. The system also includes a computing module to use the sensor data in combination with data from the leanable vehicle interface to calculate the driver behavior to produce a future desired performance, based on a specified aggressiveness, so that the performance of the leanable vehicle is optimized. The calculation may be done using a machine learning method, a rule based method, or both.

### CROSS-REFERENCE TO RELATED APPLICATION

This application claims priority to U.S. Provisional Patent Application No. 62/615,005, filed Jan. 8, 2018, which is incorporated herein by reference.

### FIELD

Embodiments generally relate to a system and method to enhance the driving performance of a leanable vehicle, such as a motorcycle.

### BACKGROUND

Leanable vehicles, such as motorcycles, are a popular form of transportation. Leanable vehicles are also used in the racing industry as a form of entertainment. In many situations, there is a need to improve performance. In other situations, there is a need to improve overall comfort level regardless of the performance. Comfort level can include, among other things, the level of safety for the driver, the apparent level of safety for the driver, the level of wear incurred by the leanable vehicle (e.g., tire wear, engine wear, drivetrain wear), and/or the level of safety for objects in the environment of the leanable vehicle. A leanable vehicle is typically driven by the driver who relies on his or her intuition and senses to make decisions. Therefore, a leanable vehicle driver may not always accurately assess the situation and/or may lack access to accurate information about the environment of the leanable vehicle, and either performance or driver comfort may be compromised.

### SUMMARY

Provided herein are some embodiments. The performance and comfort level of the leanable vehicle and the driver, independently or in combination, may be enhanced by systems that use machine learning or rule based methods (or both) to assist in the decision-making process. The comfort level of the leanable vehicle and driver can include, among other things, the level of safety for the driver, the apparent level of safety for the driver, the level of fishtailing, degree of wheel contact with the road, likelihood of vehicle tip-over, level of location and/or orientation oscillation, or other measures of instability of the operation of the leanable vehicle, the level of wear incurred by the leanable vehicle (e.g., tire wear, engine wear, drivetrain wear), and/or the level of safety for objects in the environment of the leanable vehicle. These systems may gather data and learn from the actual driving situations and predict how the leanable vehicle will behave in the future. The learned knowledge may then be applied to maximize the desired performance of the leanable vehicle.

In an embodiment, the design is directed to a system to enhance the driving performance of a leanable vehicle. The system includes a leanable vehicle interface to receive input from the driver that signifies, e.g., a desired acceleration, direction, bank angle, steering torque, steering angle, steering angle rate, throttle, ad brake and outputs to the leanable vehicle steering, throttling, clutching, shifting and braking. The system also includes a sensor interface to receive inputs from sensors on the leanable vehicle, and outputs sensor data. The system includes a computing module to receive the sensor data from the sensor interface and use both the sensor data and data from the leanable vehicle interface to calculate the driver behavior that is likely to produce a future desired performance so that the performance of the leanable vehicle is optimized.

In another embodiment, the system also includes a state estimator to combine the sensor data from the sensor interface. The state estimator can calculate a kinetic state of the leanable vehicle. In addition, the system can also contain a dynamic leanable vehicle model module to receive the kinetic state from the state estimator and external data. The dynamic leanable vehicle model module uses either the kinetic state, external data or both to calculate a physics model of the leanable vehicle and driver. In addition, the system can contain an aggressiveness engine to receive an aggressiveness index and the kinetic state, and calculate an aggressiveness factor. The system can also contain a path follower module to receive the kinetic state from the state estimator, the calculated aggressiveness factor from the aggressiveness engine and the external data such as a future position, in order to calculate commands (e.g., commands to the driver and/or commands to operate actuators of the leanable vehicle) to achieve the determined target path. The system can also contain a model based controller to receive and use the calculated physics model, the calculated aggressiveness factor and the calculated target path, along with at least one of a rule based model and machine learning based model to determine the target acceleration.

In another embodiment the system can use a calculated target path and target acceleration to determine what behavior modification is necessary to achieved the desired performance. The target path and target acceleration can be calculated using either a rule based model, a genetic algorithm, and/or or a machine learning based model.

In yet another embodiment, a method to enhance a driving performance of a leanable vehicle is provided that includes: (i) receiving, by a controller of the leanable vehicle, sensor data from one or more sensors of the leanable vehicle, wherein the sensor data is indicative of a state of the leanable vehicle; (ii) obtaining, by the controller, a vehicle control input, wherein the vehicle control input requests at least one of an acceleration, a direction, a bank angle, a steering torque, a steering angle, or a steering angle rate; (iii) determining, by the controller, a target vehicle trajectory or kinematic parameter based on an aggressiveness index, the vehicle control input, and the sensor data; (iv) determining, by the controller, a vehicle control output based on the target vehicle trajectory or kinematic parameter, wherein the vehicle control output specifies at least one of a steering operation, a throttle operation, a clutch operation, a shifting operation, or a braking operation; and (v) operating, by the controller, a vehicle control interface of the leanable vehicle to at least one of: (a) control the leanable vehicle based on the vehicle control output, or (b) provide an indication of the vehicle control output to a driver.

These and other features of the design provided herein can be better understood with reference to the drawings, description, and claims, all of which form the disclosure of this patent application.

### BRIEF DESCRIPTION OF THE DRAWINGS

The multiple drawings refer to the example embodiments of the design.

FIG. 1 illustrates an exemplary functional block diagram of a system of enhancing leanable vehicle driving performance.

FIG. 2a illustrates one embodiment configuration of the computing module.

FIG. 2b illustrates an example trajectory.

FIG. 3 illustrates one embodiment architecture that is applicable to both a machine learning model and a rule based model.

FIG. 4 illustrates an example computing systems in accordance with some embodiments.

FIG. 5 illustrates one or more networks in accordance with some embodiments.

FIG. 6a illustrates a flowchart of an embodiment of a system to enhance the driving performance of a leanable vehicle.

FIG. 6b illustrates a flowchart of an embodiment of a system to enhance the driving performance of a leanable vehicle.

FIG. 6c illustrates a flowchart of an example method.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations

In the following description, numerous specific details are set forth, such as examples of specific data signals, named components, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first sensor and a first leanable vehicle can be made. However, the specific numeric reference should not be interpreted as a literal sequential order but rather interpreted that the first sensor is different than a second sensor. Additionally, specific reference to the leanable vehicle and driver are set forth. However, it would be apparent to one of ordinary skill in the art that the leanable vehicle may also include one or more riders. Thus, the specific details set forth are merely exemplary. Also, the features implemented in one embodiment may be implemented in another embodiment where logically possible. The specific details can be varied from and still be contemplated to be within the spirit and scope of the present design.

### I. OVERVIEW

The leanable vehicle has many features and some example features will be discussed below.

In general, the system enhances a leanable vehicle driving performance by using inputs from the driver, sensors, and leanable vehicle to calculate the driver behavior (e.g., applying a steering torque, shifting a center-of-mass, operating a throttle, clutch, or shifter) and/or leanable vehicle output (e.g., applying steering torque via a highly back-drivable actuator coupled to the steering mechanisms of the leanable vehicle, operating a servo to set a throttle position, setting an engine timing), necessary to produce a future desired performance, such as a desired aggressiveness and a future position.

An aggressiveness index can be used in a variety of ways to determine driver behaviors and/or leanable vehicle outputs to achieve one or more specified goals (e.g., to minimize lap time, to maximize average speed, to increase a measure of overall vehicle performance). This can include using the aggressiveness index to determine how close to a theoretical and/or estimated maximum performance to operate the leanable vehicle and/or command a driver to act.

For example, a future leanable vehicle trajectory, maximum leanable vehicle acceleration (e.g., longitudinal, lateral, and/or total acceleration), maximum leanable vehicle velocity, maximum leanable vehicle bank angle, maximum leanable vehicle braking operation, or some other planned future vehicle behavior could be determined that is “on the edge” with respect to vehicle stability, comforts level, or some other operational constraint of interest. That is, a planned future vehicle trajectory, acceleration, or other planned future vehicle behavior that exceeded such a determined “on the edge” behavior could exceed a specified probability threshold (e.g., almost certain, more likely than not, more likely than 5%, more likely than 1%) with respect to the probability of the leanable vehicle toppling over, fishtailing, wiping out, skidding, slipping, losing contact with the ground with respect to one or more wheels, experiencing full compression of a shock absorber or other suspension element, or some other unstable event or condition.

The aggressiveness index could then be used to determine how far from such potentially unstable planned future behaviors (e.g., a fraction of such a maximum acceleration, departing by more than a margin from such a nearly unstable future trajectory) an actually effected (e.g., indicated to a driver and/or implemented by one or more actuators of the leanable vehicle) determined future vehicle behavior should be. So, where the aggressiveness index is very high (e.g., near a maximal value), the actually effected determined future leanable vehicle behavior could be very near (e.g., more likely to exhibit) toppling over, fishtailing, wiping out, skidding, slipping, losing contact with the ground with respect to one or more wheels, experiencing full compression of a shock absorber or other suspension element, or some other unstable event or condition.

The aggressiveness index could be used to determine a planned future trajectory, path, or other future kinematic variables of the leanable vehicle (e.g., to determine a trajectory through a turn that is more or less aggressive with respect to speed, acceleration, or other parameters at the apex of the turn and/or more or less aggressive with respect to the braking operations necessary to achieve a determine velocity at the apex of the turn). Additionally or alternatively, the aggressiveness index could be used to determine more immediate operations of the leanable vehicle, e.g., to determine how close to a predicted maximum acceleration (e.g., an acceleration near the traction limits of the leanable vehicle under present environmental conditions) to accelerate the leanable vehicle, e.g., during straightaway driving.

Such determinations could also be made based on uncertainty with respect to the information known about the leanable vehicle's performance or overall state (e.g., tire wear, tire pressure) and/or environmental conditions (e.g., weather, the coefficient of friction or other properties of the road beneath the leanable vehicle, the coefficient of friction or other properties of the road along a planned future path of the leanable vehicle). Such information could be determined by the leanable vehicle itself (e.g., based on past performance of the leanable vehicle along a particular section of road), from other leanable vehicles, and/or from some other remote server or other information source (e.g., a cloud computing service).

A leanable vehicle may be a vehicle that has two, three or more wheels that is capable of leaning during operation or while standing still. For example, a vehicle such as a motorcycle may be considered a leanable vehicle due to the fact that the motorcycle can deviate from being perpendicular to the ground as it is driven or stands still. Similarly, a three wheel scooter or motorcycle may also be considered a leanable vehicle due to its ability to be at an incline while driving. Any of these leanable vehicles may tilt during operation or while standing still. Such a leanable vehicle may be driven by a human driver or by a robotic driver. Such a robotic driver could include actuators or other effectors capable of operating control interfaces of the leanable vehicle (e.g., handlebars or steering wheel, throttle, clutch, and/or shifter pedals), controlling the location of a mass in order to affect the overall center-of-mass of the leanable vehicle, or to engage in some other driving behaviors. Such a robotic driver could include a controller that is independent from one or more controllers for controlling the leanable vehicle and/or could have one or more controllers in common with the leanable vehicle.

In one embodiment, the system includes a leanable vehicle interface. A leanable vehicle interface includes the mechanisms used by a driver to control the operation of the leanable vehicle (e.g., handlebars or other steering mechanisms, throttle and/or brake controlling grips, clutch and/or shifting pedals, switches, buttons, or other mechanisms for providing electronic inputs to the leanable vehicle), sensors for electronically detecting such inputs, displays, transmitters, or other outputs for providing information to the driver, and actuators for effecting and/or augmenting such inputs and/or for providing feedback to a driver regarding such inputs (e.g., to inject a vibration, a pulse of force, to overlay a force field, or some other tactile, haptic, and/or force feedback into the steering or other input mechanism in order to indicate or otherwise provide information to the driver regarding a suggested future behavior). Such a leanable vehicle interface can be operated to receive input from the driver such as acceleration, direction, bank angle, steering torque, steering angle, steering angle rate, and outputs to the leanable vehicle steering, throttling, clutching, shifting and braking.

The system also includes a sensor interface to receive inputs from sensors on the leanable vehicle and outputs sensor data in a form that can be used by the system. The system includes a controller (e.g., a computing module disposed on the leanable vehicle, a server, laptop computer, or cloud computing system in communication with the system(s) of the leanable vehicle, etc.) to receive the sensor data from the sensor interface in addition to data from the leanable vehicle interface to calculate the driver behavior to produce a future desired performance, such as a desired aggressiveness and a future position, so that the performance of the leanable vehicle is optimized.

The system (e.g., a controller of the system) may implement the methods described herein in a variety of ways. For example, the system may include a state estimator (implemented, e.g., as an application or other executable code in a controller) to receive the sensor data from the sensor interface. The state estimator can calculate a kinetic state of the leanable vehicle. In addition, the system can also contain a dynamic leanable vehicle model module to receive the kinetic state from the state estimator and external data. The dynamic leanable vehicle model module uses either the kinetic state, external data or both to calculate a physics model of the leanable vehicle and driver. In addition, the system can contain an aggressiveness engine to receive an aggressiveness index and the kinetic state, and calculate an aggressiveness factor. The system can also contain a path follower module to receive the kinetic state from the state estimator, the calculated aggressiveness factor from the aggressiveness engine and the external data such as a future position, in order to calculate the target path. The system can also contain a model based controller to receive and use the calculated physics model, the calculated aggressiveness factor and the calculated target path, along with at least one of a rule based model and machine learning based model to determine the target acceleration.

In another embodiment the system can use a calculated target path and target acceleration to determine what behavior modification is necessary to achieved the desired performance. The target path and target acceleration can be calculated using either a rule based model or a machine learning based model.

In another embodiment, the system can receive external data such as weather, road conditions, road hazards and use that information in the calculations in order to enhance future performance.

In another embodiment, the system can use information obtained about past performance in the calculations in order to enhance future performance.

### II. EXAMPLE SYSTEMS

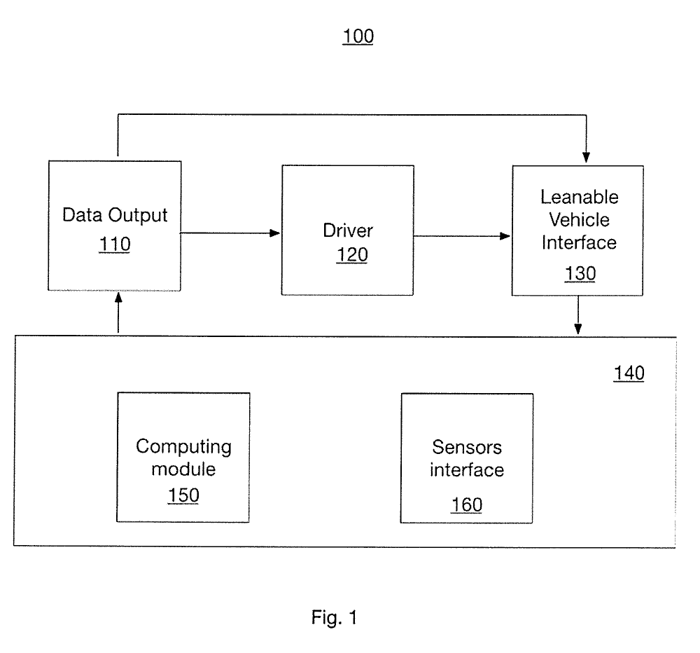

FIG. 1 illustrates a functional block diagram of a leanable vehicle and a driver (120), where the operation of a leanable vehicle includes a computing module as described herein to improve the performance of the leanable vehicle and driver (e.g., a computing module that includes machine learning capability). As will be explained below, the functional block that provides the machine learning or other performance improvement capability may be configured in several ways including being implemented within the leanable vehicle, in a cloud computing environment, in a controller or other computing device of the driver if the driver is a robot, in an off-line manner or a combination one or several of the configurations listed. As shown in FIG. 1, the functional block in the leanable vehicle includes a computing module (150) and a sensor interface (160) (other blocks may also exist in practice). The driver (120) drives the leanable vehicle using the leanable vehicle interface (130).

The sensors operated or otherwise interacted with by the sensors interface (160) can include a variety of sensors configured to detect properties of the leanable vehicle, driver (120), the environment of the leanable vehicle (e.g., weather, road conditions, the presence of other vehicles or other obstacles, the location and shape of roadway ahead of the leanable vehicle) or other information that could assist in operating the leanable vehicle and/or improving the performance of the leanable vehicle. For example, the sensors could include one or more of a camera, a speed sensor, an inertial sensor, a steering angle sensor, a bank angle sensor, a tire slippage sensor, a tire wear sensor, a tire pressure sensor, a throttle position sensor, a cam position sensor, a gear selection sensor, a bank angle sensor, an oxygen sensor, a weight sensor, an oil pressure sensor, or an oil purity sensor. Such sensors could include any elements necessary to detect a property of interest, including other sensors. For example, a steering angle sensor could include a rotary encoder, a camera configured to image the location of a handlebar of other steering component relative to the leanable vehicle, or some other elements and/or other sensors that could be operated to determine the angle of steering of the leanable vehicle.

In another example, a location sensor of the leanable vehicle could be configured to determine the location of the leanable vehicle (e.g., the absolute location of the leanable vehicle relative to the Earth, a location and/or orientation of the leanable vehicle relative to a track, a roadway, other leanable vehicles, an obstacle, or some other object or location). Such a location sensor could include a GPS receiver, one or more light sensors to detect temporally, spectrally, and/or spatially patterned light emitted by one or more beacons in order to determine the location of the vehicle relative to the beacon(s), acceleration and/or velocity sensors in order to detect movement of the vehicle, tire rotation sensors and/or steering angle sensors to detect movement of the vehicle, one or more cameras to detect objects in the environment of the vehicle (e.g., in order to determine the location of the vehicle based on the known locations of known objects imaged by the camera(s), or some other sensor(s) or other element(s) that can be operated to generate location-related information.

In one embodiment the leanable vehicle interface (130) can include actuator(s) for controlling and/or affecting the steering (257a), brake (257e), etc. Such actuators may be operated to control such vehicle inputs and/or to augment a driver's control of such inputs. Additionally or alternatively, the leanable vehicle interface (130) could be operated to use such actuators to provide feedback to a driver regarding such inputs (e.g., to inject a vibration, a pulse of force, to overlay a force field, or some other tactile, haptic, and/or force feedback into the steering or other input mechanism in order to indicate or otherwise provide information to the driver regarding a suggested future behavior). The leanable vehicle interface (130) can additionally include the mechanisms used by a driver to control the operation of the leanable vehicle (e.g., handlebars or other steering mechanisms, throttle and/or brake controlling grips, clutch and/or shifting pedals, switches, buttons, or other mechanisms for providing electronic inputs to the leanable vehicle), sensors for electronically detecting such inputs, displays, transmitters, or other outputs for providing information to the driver.

Information (e.g., determined future trajectories, accelerations, velocities, throttle operations, steering torques, bank angles, or other behaviors determined using the methods described herein in order to improve the performance of a leanable vehicle) computed or obtained by the functional blocks within the leanable vehicle may be communicated to the driver (120) through the data output (110) and/or the leanable vehicle interface (130). The data output (110) may include a display such as but not limited to a dashboard, a wireless output, etc. As mentioned above, the driver (120) may be a robot or a human driver. In examples where the driver (120) is a robotic driver, the data output (110) could include an Ethernet transceiver, a CAN bus transceiver, a twisted pair transceiver, a Bluetooth radio, a WiFi radio, or some other wired or wireless means for communicating information to and/or from the robotic driver. The driver (120) and leanable vehicle may be driven in various locations including but not limited to racetracks, or roads and highways and off-road locations. The computing module (150) may be configured in multiple ways including being self-contained within the driver (120) (if the driver is a robot), within the leanable vehicle, in a remote server or other remote computing device or system (e.g., a cloud computing service) that is in communication with the leanable vehicle, or distributed amongst these options.

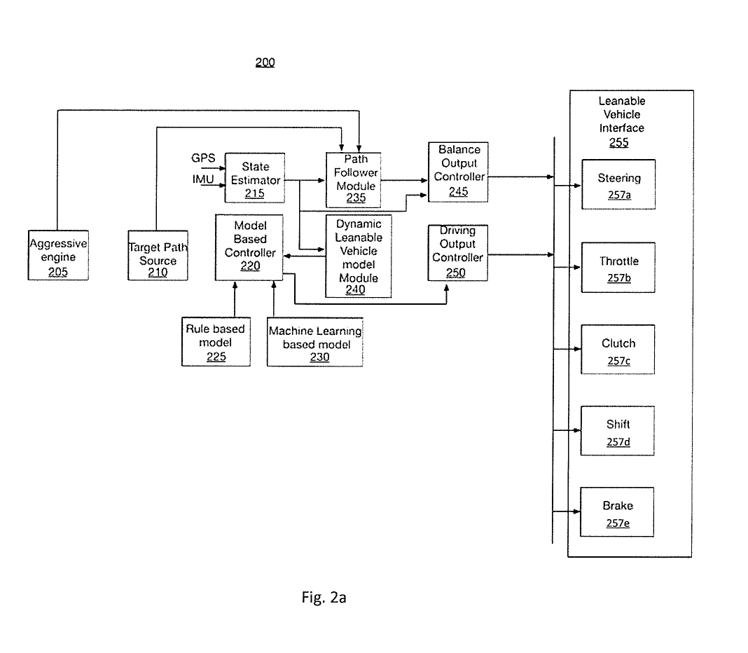

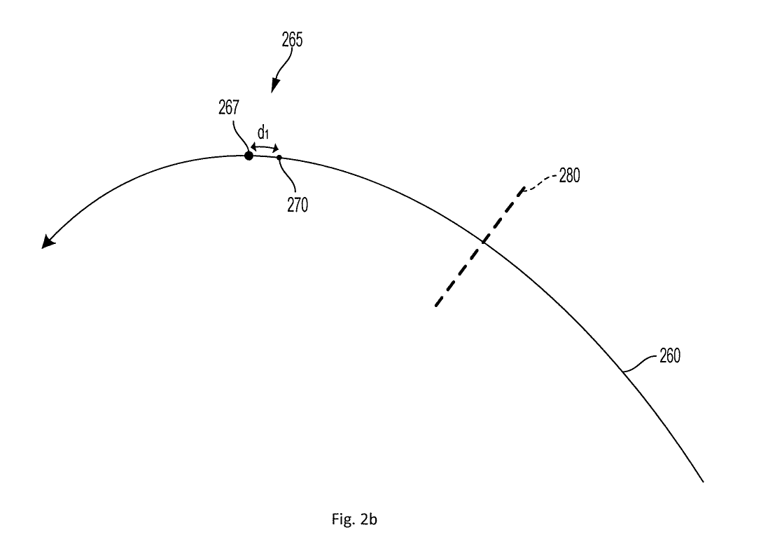

FIG. 2a illustrates one embodiment of the computing module (150). As stated earlier, this computing module (150) may be configured in various ways. Also, the computing module (150) may be implemented within the leanable vehicle or within the driver (120), if the driver is a robot, or may be implemented across multiple components. As illustrated in FIG. 2a, the leanable vehicle interface (130) may receive input from one or multiple output controllers. FIG. 2a shows two output controllers—a balance output controller (245) and a driving output controller (250). The output controllers generate commands that are sent to the leanable vehicle interface (130), based on calculations that occur within the controllers. In alternative embodiments, instructions can be sent to the leanable vehicle driver instead of or in addition to the commands sent to the leanable vehicle interface (130). More details about these output controllers will be provided below. In additional embodiments, there may be more or fewer output controllers.

In one embodiment the computing module (150) is implemented within the robot (acting as a driver), and the robot actuates the leanable vehicle interface to control the leanable vehicle.

In another embodiment the computing module (150) is implemented within the leanable vehicle, and one of multiple techniques of actuating the leanable vehicle interface (130) is utilized.

In another embodiment, an internal control module may control the leanable vehicle interface (130). This may be done by coupling an internal control module to the leanable vehicle interface (130) such that all controls are completely enclosed within the leanable vehicle.

In another embodiment, a display screen may be used to communicate information to a human driver who may then choose to act accordingly.

In another embodiment, a combination of internal control and actuation through a driver (120) (robot or human) may be utilized (e.g., as a “fly-by-wire” system).

In some embodiments, the leanable vehicle is configured with a machine-readable storage medium to store information such as calculated target acceleration(s), calculated target path(s) or trajectory(s), kinetic state(s), calculated aggressiveness factor(s), driver input(s), and/or external data for storage and off-line analysis. Such a configuration can allow a driver to consult this recorded information in order to review their performance on a previous occasion when the leanable vehicle was driven and take that information into account during future occasions when the leanable vehicle is driven. For example, the leanable vehicle driver may be able to determine whether the performance could have been modified to be more comfortable or more aggressive and utilize this information to change driving behavior on future driving occasions.

As stated above, the output controllers generate commands that control the operation of the leanable vehicle through the leanable vehicle interface (130). In alternative embodiments, instructions can be sent to the leanable vehicle driver (120) that are human interpretable instructions. These instructions can be sent instead or in addition to the commands sent to the leanable vehicle interface (130). Thus, a vehicle control output could include one or both of an output to directly control the behavior of the leanable vehicle (e.g., by operating an actuator to apply a steering torque to the front wheel of the leanable vehicle) or an output to indicate to a driver to engage in a control operation or other behavior (e.g., to apply a steering torque to the handlebars, to shift a center of mass of the driver). Such an output to indicate a behavior to the driver could include providing an audiovisual output via, e.g., a headphone jack, a Bluetooth radio, a display, or some other means. Additionally or alternatively, providing an output could include operating one or more actuators (e.g., servos, motors, hydraulics, solenoids, valves) of the leanable vehicle interface (130) to inject a vibration, a pulse of force, to overlay a force field, or some other tactile, haptic, and/or force feedback into the steering or other input mechanism in order to indicate or otherwise provide information to the driver regarding a suggested future behavior. In examples wherein the driver is a robotic driver, an output to indicate a behavior to the driver could include a machine-readable transmission via a wired or wireless communication medium.

The balance output controller (245) generates commands to maintain the balance of the leanable vehicle (e.g., steering commands). This can include generating commands such that the angle of the leanable vehicle matches a commanded/predicted angle (e.g., a bank angle determined as part of a predicted target trajectory and/or kinematic variable) of the leanable vehicle. For example, the balance output controller (245) can generate commands to control steering (257a). Alternatively, an instruction on how to control steering (257a) can be sent to the driver (120).

The balance output controller generates a command that produces, e.g., a torque that is subsequently applied to the steering (257a). Such a torque may be applied via a highly back-drivable actuator in order to increase the overall stability of the leanable vehicle when the leanable vehicle is traveling faster than a minimum speed (due, e.g., to the high back-drivability of the actuator allowing the gyroscopic effects of the rotating front wheel to exert stabilizing torques onto the steering mechanism). The inputs of the balance output controller (245) are the target bank angle provided by the path follower module (235), the current leanable vehicle velocity, the steering angle, the steering angle rate and the suspension position. The last three parameters are utilized to adjust the steering torque that is applied when the front wheel is almost fully unloaded, in order to avoid causing the front wheel to turn significantly when not in contact with the ground. Otherwise, the balance output controller (245) may operate based on fewer inputs, e.g., based on a difference between a detected bank angle of the leanable vehicle and a target bank angle. The balance output controller (245) can be configured (e.g., programmed) with the assumption that the wheels of the leanable vehicle are maintained in contact with the ground, except for in the aforementioned situation.

Methods for control of a leanable vehicle described herein can include determining throttle, clutch, shifter, front brake, rear brake, or other outputs in order to control the longitudinal acceleration of the leanable vehicle along the long axis of the leanable vehicle. In order to increase the velocity, decrease the lap time, or otherwise increase the performance of the leanable vehicle, the longitudinal acceleration could be maximized, subject to constraints related, e.g., to the comfort level and stability of the operation of the leanable vehicle. The longitudinal acceleration forms part of the total acceleration of the leanable vehicle; the total acceleration also including a lateral acceleration component. The lateral acceleration component can be related to banking/turning of the leanable vehicle (e.g., based on the velocity of the leanable vehicle along with the curvature of the trajectory/steering of the leanable vehicle).

In order to ensure the stability and comfort level of the leanable vehicle, the total acceleration of the leanable vehicle could be maintained below a maximum acceleration (e.g., a maximum acceleration determined for a particular time/location based, e.g., on a road surface coefficient of friction determined for the particular time/location) in order to avoid skidding, wheel slippage, loss of wheel contact with the road surface, or other unstable conditions. In order to do so, e.g., the lateral acceleration could be determined from the velocity and bank angle/curvature and a maximal longitudinal acceleration could be determined such that the total of the determined lateral acceleration and the maximal longitudinal acceleration is less than or equal to the determined maximum total acceleration (e.g., using the friction circle). Additionally or alternatively, a maximum longitudinal acceleration could be determined based on the location of the center of mass of the leanable vehicle, in order to prevent the rear wheel and/or front wheel from losing contact with the ground. The vehicle control outputs can then be determined to comport the resulting longitudinal acceleration with a determined target acceleration/trajectory/kinematic parameter while maintaining the vehicle acceleration below one or more of the aforementioned maximum acceleration constraints.

In order to effect a determined longitudinal acceleration, an output throttle operation (e.g., a throttle setting controlled by an actuator and/or indicated to a driver) could be determined based on the longitudinal acceleration and a detected engine rotational speed (e.g., engine RPM). This determination could include applying the longitudinal acceleration and engine rotational speed to a two-dimensional lookup table, a two-dimensional function, or some other method for determining the experimentally or theoretically-determined optimal throttle setting to achieve a particular longitudinal acceleration, given the measured engine rotational speed.

The driving output controller (250) generates additional commands that control the operation of the leanable vehicle through the leanable vehicle interfaces (130). The driving output controller (250) may generate commands including but not limited to controls that control the throttle (257b), the shift (257d), the clutch (257c), and the brake (257e), which can be the front or rear brake, in order to control the longitudinal acceleration of the leanable vehicle. Similarly, instructions can be sent to the driver (120) on how to control the above-mentioned items. The inputs to the driving output controller include velocity and acceleration. One function of this block is to apply a velocity or acceleration profile (or both) such that one or multiple specific criteria are met. As an example, one criterion may be to improve lap time. Another criterion may be to drive in comfort mode.

As noted above, a target trajectory and/or associated kinematic parameter(s) (e.g., maximum acceleration at one or more points along the target trajectory, a target velocity and/or bank angle at one or more points along the target trajectory) can be determined as a goal for the future behavior of a leanable vehicle. Such a trajectory and/or kinematic parameter(s) could be determined based on past performance of the leanable vehicle (or other leanable vehicles) along or near the location of the target trajectory (e.g., a roadway or portion of a racetrack), information about environmental conditions along the path (e.g., weather, the camber, resilience, coefficient-of-friction, and/or other properties of the roadway at one or more points along the trajectory), information about the leanable vehicle (e.g., degree of tire tread wear, tire pressure, tire geometry and/or elasticity), or other relevant information. Thus, the controller of the leanable vehicle could iterate, each time it travels through a particular area (e.g., a particular section of roadway, a particular portion of a racetrack) in order to increase performance (e.g., reduce time to travel through the region, reduce lap time around a racetrack) and/or to more accurately learn about the environment in order to closer approach a theoretical maximum performance without experiencing tipping over, wipeout, wheel(s) up, fishtailing, going wide through a turn, or some other instability or other unwanted behavior. The degree to which the controller attempts to “learn” the environment vs. exploit existing knowledge about the environment (e.g., to behave closer to the edge of stability, with respect to the then-current estimates of the properties of the environment/the leanable vehicle) could be set be the aggressiveness index (e.g., a higher aggressiveness index is more likely to result in increased performance, but also more likely to result in instability).

Once a target trajectory and/or kinematic parameter(s) have been determined, the controller can generate control outputs such that the leanable vehicle behavior follows the determined target trajectory and/or kinematic parameter(s). Thus, the path follower module (235) functional block produces a path delta command. The input to the path follower module (235) functional block includes the planned path/target trajectory, the current position along the path/target trajectory, the kinetic state of the leanable vehicle and the aggressiveness factor. The target trajectory and/or kinematic parameters can be determined once and/or updated repeatedly (e.g., based on the determined present location/bank angle/deviation from a previous target trajectory/other properties of the leanable vehicle, based on the receipt of updated and/or additional information about the environment/road surface).

In order to determine a future trajectory and/or path for the leanable vehicle to follow and/or to determine some other kinematic parameter defining current or future vehicle behavior, a model of the leanable vehicle and/or of its environment could be used. For example, the dynamic leanable vehicle model module (240) functional block provides a physics model of the leanable vehicle and the driver (120). This model may represent many physical properties of the leanable vehicle such as its center of gravity, its wheelbase, caster angle, trail, tire width, wheel rotational inertia and so forth. Those properties may be used by the path follower module (235) to convert turn radius and velocity to bank angle and to adjust this bank angle command based on the tire width. The balance output controller (245) may also use this model to compensate for gyroscopic effects caused by the rotation of the front wheel.

The state estimator (215) functional block calculates the position and velocity of the leanable vehicle given position data. It may also retain the prior state and use that information to predict the current state. Position data can be inputs such as GPS, IMU and Lidar devices or can be calculated based on measuring the position of the leanable vehicle relative to a landmark with a previously determined position. Measurement of the leanable vehicle position relative to a known landmark can be done in a number of ways including using stereovision for visual based landmark or using multilateration for radio based landmarks. Absolute and/or relative leanable vehicle position could be detected using a GPS receiver, one or more light sensors to detect temporally, spectrally, and/or spatially patterned light emitted by one or more beacons in order to determine the location of the vehicle relative to the beacon(s), acceleration and/or velocity sensors in order to detect movement of the vehicle, tire rotation sensors and/or steering angle sensors to detect movement of the vehicle, one or more cameras to detect objects in the environment of the vehicle (e.g., in order to determine the location of the vehicle based on the known locations of known objects imaged by the camera(s), or some other sensor(s) or other element(s) that can be operated to generate location-related information.

The calculations within the model based controller (220) functional block may be applied to result in an appropriate acceleration to be applied at a particular point in time and location (e.g., to correspond to a predicted trajectory or other kinematic parameter(s) relating to a predicted behavior of the leanable vehicle). Such acceleration calculations also include the calculation of deceleration profiles (e.g., deceleration profiles while entering a turn of a predicted vehicle trajectory). The appropriate acceleration profiles may be determined by goals that are set by the aggressiveness engine (205). To explain this further, the aggressiveness engine (205) can provide an aggressiveness index based on the driver (120) input. Thus, a high aggressiveness index, indicating that the driver (120) wants to ride more aggressively, may cause the model based controller (220) to calculate accelerations that are closer to a maximum possible acceleration.

As illustrated in FIG. 2a, there are multiple ways to configure the model based controller (220). In one embodiment, a rule based model (225) may be utilized. In this model, for a specific aggressiveness index and a specific location, a specific acceleration may be specified. Thus, a table such as Table 1 may be utilized within such a model.

TABLE 1

| Aggressiveness Index | GPS Loc | Acceleration |
|---|---|---|
| Aᵢ | Latₚ, Longₚ | D1 |
| Aᵢ | Latₚ₊₁, Longₚ₊₁ | D2 |
| . . . | . . . | . . . |

In this table, for an aggressive index Ai, for specific latitude (lat) and longitude (long) or other method of specifying location (e.g., relative location along a racetrack), a specific acceleration such as D1 may be applied. The accelerations may be calculated a priori based on prior experimentation or modeling or other techniques. Thus, in a racetrack, a higher aggressive index may be used, as commanded by a driver (120). In normal non-racetrack driving, this table may also be used to ensure comfortable driving. A particular acceleration may be applied in response to determining that the leanable vehicle is at or near the particular location corresponding to the particular acceleration, e.g., in response to determining that the location of the leanable vehicle differs from the particular location by less than a specified distance.

In one embodiment, a machine learning based model (230) may be utilized for the model based controller (220). Here, in contrast to the rule based model (225), a machine learning based model (230) may learn the optimal acceleration to be applied at a particular location. The machine learning may include other parameters such as environmental conditions, time of day, etc.

In some examples, a determined target trajectory for the leanable vehicle could include a turn (e.g., corresponding to a turn of a racetrack). In such examples, the target trajectory could be determined such that the leanable vehicle's acceleration at the peak of the turn does not exceed a maximum acceleration. Such a maximum acceleration could be determined, based on an aggression index, as a fraction of a determined acceleration level that would likely cause the leanable vehicle to tip over, go wide, skid, fishtail, or experience some other instability or other unwanted condition.

In some examples, the target trajectory includes a turn and an indication of a braking commencement point, prior to the apex of the turn, that is the point along the trajectory at which the leanable vehicle should commence braking in order to avoid instability during the braking leading up to the apex and to avoid instability at the apex of the turn. Such a determination could be performed based on an aggressiveness index, e.g., in order to provide a greater margin of error (e.g., to provide an earlier braking commencement point) for less aggressive aggressiveness indices while decreasing the likely overall performance of the leanable vehicle (e.g., increasing a time to transit through the turn).

Determining such a braking commencement point is illustrated in FIG. 2b, which includes an example target trajectory 260. The target trajectory includes a turn 265 that has an apex 267. Determining a braking commencement point 280 (e.g., a point along the target trajectory 260, a plane, line, or other manifold indicating a boundary, relative to the target trajectory 260, in some other manner) could include determining a pre-apex point 270 along the target trajectory 260 that precedes the apex point 267 by a distance (“d₁”) that is based on the aggressiveness index (e.g., more aggressive aggressiveness indices result in smaller, or zero, distances d₁). Maximum acceleration values could be determined for the leanable vehicle for a plurality of points along the target trajectory 260 preceding the pre-apex point 270 (e.g., based on lateral accelerations determined based on predicted velocities and trajectory curvatures at the plurality of points). These maximum acceleration values could then be used to determine the braking commencement point 280 sufficiently before the pre-apex point 270 such that braking can be applied, between the braking commencement point 280 and the pre-apex point 270, to reduce the velocity of the leanable vehicle from a starting velocity at the pre-apex point 270 (e.g., a cruising velocity, an estimated leanable vehicle velocity at the braking commencement point 280) to a target velocity at the pre-apex point (e.g., a target velocity that, when combined with the curvature of the trajectory at the apex 267 and/or pre-apex point 270, results in a lateral acceleration that is less than a maximum acceleration/unlikely to result in vehicle instability) while maintaining the maximum acceleration of the leanable vehicle, at the plurality of points between the braking commencement point 280 and the pre-apex point 270, below the respective determined maximum acceleration values for the plurality of points.

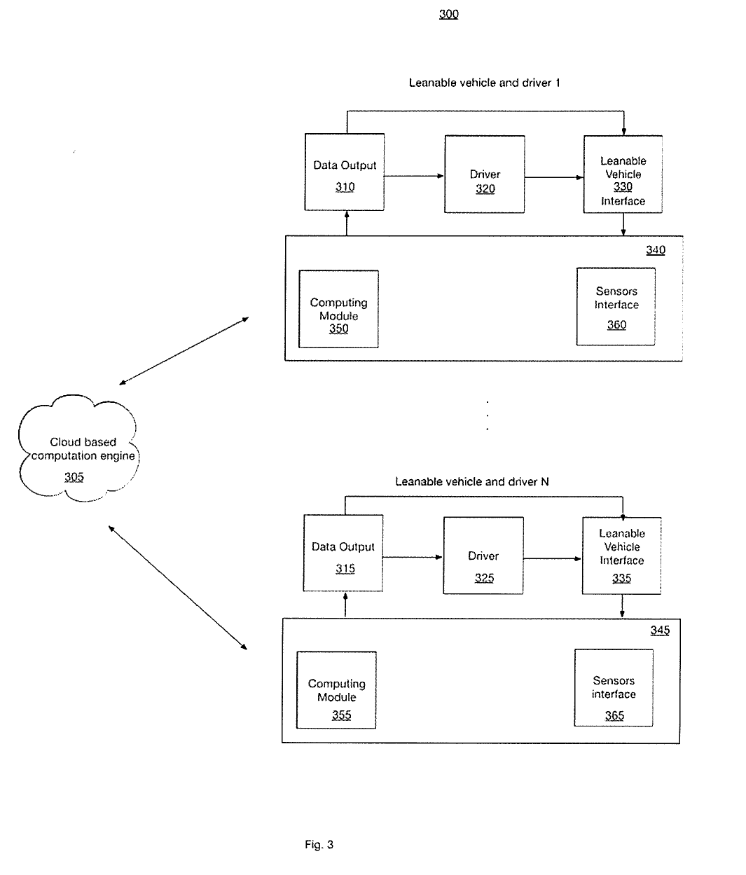

While FIG. 2a provides one specific configuration of the computing module (150), FIG. 3 provides a more general architecture that is applicable to both a machine learning based model (230) and a rule based model (225). In FIG. 3, multiple leanable vehicle and driver sets are illustrated although all concepts apply even if there is one set. Also, although a cloud based computation engine (305) is illustrated, as shown in FIG. 2a the cloud facility is not required. The machine learning concepts and the rule based concepts are now presented within the context of FIG. 3 with the understanding of the comments above.

### Machine Learning

The machine learning computation may occur within the leanable vehicle or within the driver (120) (if the driver is a robot), within the cloud computation engine (305), or some combination of these locations. In one embodiment, the GPS, the environmental data, and the state of the leanable vehicle are recorded within the computation module (150). The comfort level of the leanable vehicle could be also recorded for this set of data. The comfort level may be categorized into multiple enumerated categories, e.g., “Comfortable,” “Uncomfortable,” “near the edge of discomfort,” etc. For example, if the leanable vehicle did not slip, the comfort level would be recorded as “Comfortable.” In contrast, if the leanable vehicle did slip or was beginning to slip, then a comfort level of “Uncomfortable” or “near the edge of discomfort” may be recorded. The computing module (150) may determine the appropriate comfort level based on the data from the sensor interface (160). For example, if the wheels are not spinning at the same rate (e.g., spinning at respective rates that differ by more than a programmable adjustable threshold), then the computing module (150) may determine that the leanable vehicle is slipping. This “slipping” status could be associated with the environmental conditions and the internal controls imposed on the leanable vehicle that coincided with the leanable vehicle “slipping.”

With this data set stored, the next time these same set of conditions or a similar set of conditions are encountered either by this particular leanable vehicle and driver or by a different leanable vehicle and/or driver, this knowledge can be made known to the driver (robotic or human) and/or to the internal control mechanisms prior to reaching that specific location such that appropriate actions may be taken in driving through this location. The role of the machine learning functional block in this case may range widely from making a determination if the current set of conditions is similar to a condition that has been encountered in the past to deriving information that may be broadly applicable to all drivers, regardless of what type or model of leanable vehicle is being driven. An example of such derived information is the coefficient-of-friction of the surface at a particular location. Such coefficient of friction information is largely independent of the leanable vehicle. The effective coefficient-of-friction, which depends on the coefficient of friction at the particular location as well as the properties of the leanable vehicle, may then be calculated within the computing module (150). This computation may be accomplished based on a pre-determined kinetic model of the leanable vehicle.

In one embodiment the machine leaning functional block acts to aggregate and analyze data from multiple leanable vehicles and drivers. As multiple leanable vehicles and drivers travel through various locations, various data such as but not limited to environmental data, leanable vehicle state data, and comfort level data are collected and may be transmitted to the cloud based computation engine (305). This engine may also include a machine learning functional block that may perform a broad range of computations. As more data becomes available for the same location, a confidence in calculations derived from such data, e.g., the coefficient-of-friction of the road surface at the location, may increase. Additionally, data from additional locations could become available. This data may be disseminated to one or multiple leanable vehicles (e.g., as part of a subscription service).

The example above discussed the use of machine learning during everyday use of a leanable vehicle (e.g., to commute to work). One benefit of such learning is to improve driver comfort level as more data about roads becomes available. Additionally or alternatively, these methods may be applied to the operation of a leanable vehicle on a racetrack or other competitive motorsports environment.

In a racetrack or other motorsports application, a primary goal is to reduce lap time and/or to increase speed. Regions of a racetrack may be characterized in terms of location along the track (e.g., indexed relative to the starting line) as well as other characteristics such as but not limited to coefficient-of-friction, incline, surface stability, or other environmental properties. The curves of the track can present challenging situations as appropriate acceleration and deceleration through a turn may make a significant impact on the lap timing. Thus, one technique to improve the lap time is to use a machine learning based model (230).

In one embodiment, during the training period, the machine learning based model (230) functional block may acquire environmental and internal data. Initially, during this training period, the aggressiveness index may be set to a low value deliberately so that training data may be acquired. With the aggressiveness index low, the leanable vehicle may operate at some lower percentage such as 50% of its maximum capability. With additional laps, the aggressiveness index may be increased automatically in steps or manually. Each time, the machine learning based model (230) functional block learns some new data, e.g., a point along the track to start decelerating into a turn and/or to being accelerating out of a turn. In some instances, when there is no danger or a reduced danger of losing balance or experiencing some other instability condition, the aggressiveness index may push the leanable vehicle performance to its performance limit (e.g., a theoretical or practical minimum lap time, maximum average speed, or some other maximal performance metric). Derived and/or measured information such as but not limited to coefficient-of-friction of the road surface at one or more locations may then converge to a “true” or otherwise highly accurate value with such trials. Eventually, with multiple trials, it may be possible for the machine learning based model (230) functional block to suggest the most optimal route and/or the most optimal acceleration and deceleration profiles for each location on the track.

Depending on the kinematic modeling of leanable vehicles and their drivers, it may be possible to use some or all of the above information determined about a particular track on a different leanable vehicle and driver set. This may be advantageous, as the learning from one leanable vehicle and their driver may be applied to a different set, the second set perhaps requiring a smaller amount of training time in order to, e.g., converge on an “optimal” route along the track.

### Rule Based Performance

As noted above and illustrated in FIG. 2a, in one embodiment the computing module (150) may include a rule based model (225) functional block. In contrast to the machine learning based model (230) functional block, the rule based model (225) functional block utilizes one or more look-up-tables, formulas, or other heuristically-based elements. In some configurations, advantages may be realized by using rule based methods alone or in combination with the machine learning methods.

For example, during everyday driving (e.g., commuting to work), where comfort is a primary concern, the heuristic data (that may include observational data), may be linked to specific locations. This data may be displayed to and/or acted upon by the driver (120) or the internal control mechanisms. For example, through prior observations it may be known that at a particular location (e.g., a particular address, a particular location along a route, a particular GPS coordinate), the lane markings are not visible. This could present an uncomfortable situation for the leanable vehicle. Thus, with this knowledge, a rule may be built using tables or other computational methods that recommends an alternate route to the driver.

This example may be used to compare and contrast the rule based methods and the machine learning based methods. The machine learning based methods may be able to predict the uncomfortable situation based on machine vision through sensors (cameras) installed on the leanable vehicles without a human-in-the-loop. The rule based methods may require a human in the loop to interpret the data and make such a determination.

In the example of a racetrack, rule based model (225) may be similarly configured according to location on the track. The most appropriate velocity and/or acceleration (e.g., with respect to minimizing lap time) for each location along the track may be recorded based on prior experimentation. A human-in-the-loop may be necessary to make a decision on which set tables or heuristic knowledge to apply. In contrast, the machine learning based model (230) may not need to have the human-in-the-loop; decisions may be made in a real-time or in a semi real-time manner.

As the rule based model (225) and the machine learning based model (230) have their own advantages, both methods may be utilized in combination. In the training period, the leanable vehicle may be operated with the rule based model (225). However, as more data becomes available, the tables may be modified and/or new tables may be created with the machine learning based model (230). An additional advantage of this approach may be realized when sufficient data is not available for the machine learning based model (230). This may happen for example during everyday driving for locations that are remote or not frequented by drivers. Here a location-agnostic rule-based method may be used, but as more and more data becomes available, machine learning may be used.

### Network

A number of vehicles, such as leanable vehicles, back-end systems, electronic systems and devices can communicate with each other in a network environment (590) in accordance with the embodiments discussed herein. The network environment includes a communications network. The network environment can include one or more networks selected from an optical network, a cellular network, the Internet, a Local Area Network (“LAN”), a Wide Area Network (“WAN”), a satellite network, a fiber network, a cable network, and/or combinations thereof. In some embodiments, the communications network is the Internet. There may be many server computing systems and many client computing systems connected to each other via the communications network.

The communications network can connect one or more server computing systems selected from at least a first server computing system and a second server computing system to each other and to at least one or more client computing systems as well. The server computing systems can each optionally include organized data structures such as databases. Each of the one or more server computing systems can have one or more virtual server computing systems, and multiple virtual server computing systems can be implemented by design. Each of the one or more server computing systems can have one or more firewalls to protect data integrity.

The one or more client computing systems can be selected from a first leanable vehicle (511), a second leanable vehicle (512), a first mobile computing device (530) (e.g., smartphone with an Android-based operating system), a second mobile computing device (e.g., smartphone with an iOS-based operating system—not shown in the Figure), a first wearable electronic device (550) (e.g., a smartwatch), a first laptop computer (580), a first tablet (520), a first desktop (570) and the like. The client computing system can include, for example, the software application or the hardware-based system in which may be able exchange communications with the first leanable vehicle (511), and/or the second leanable vehicle (512). Each of the one or more client computing systems can have one or more firewalls to protect data integrity.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. No hierarchy is implied unless explicitly stated. Both functions can be in a single communicating system or device, in which case, the client-server and server-client relationship can be viewed as peer-to-peer. Thus, if the first laptop computer (580) (e.g., the client computing system) and the server computing system can both initiate and respond to communications, their communications can be viewed as peer-to-peer. Additionally, the server computing systems include circuitry and software enabling communication with each other across the network.

Any one or more of the server computing systems can be a cloud computing system or service (540). A cloud provider can install and operate application software in a cloud and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (“HTTP”), to engage in a request and response cycle with an application on a client computing system such as a web-browser application resident on the client computing system. The cloud-based remote access can be accessed by a smartphone, a desktop computer, a tablet, or any other client computing systems, anytime and/or anywhere. The cloud-based remote access is coded to engage in 1) the request and response cycle from all web browser based applications, 3) the request and response cycle from a dedicated on-line server, 4) the request and response cycle directly between a native application resident on a client device and the cloud-based remote access to another client computing system, and 5) combinations of these.

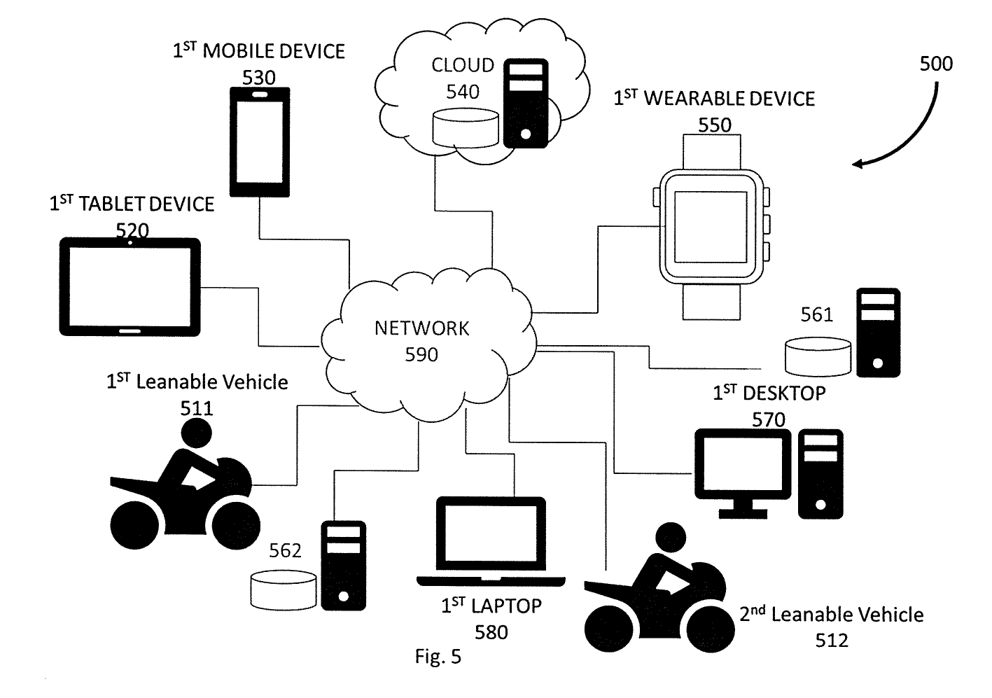

As can be seen in FIG. 5, a cloud computational engine (305) as illustrated in FIG. 3 can be implemented in the cloud (540). In the cloud based computing scenario, various data such as but not limited to environmental data, leanable vehicle state data, and comfort level data are collected and may be transmitted to the cloud using any one of the communication methods described above. This engine may also include a machine learning based model (230) functional block that may accomplish a broad range of computations. For example, as more data becomes available for the same location, the confidence in the calculations derived for that location such as but not limited to the coefficient-of-friction of the road surface at the location may increase. Additionally, data from more locations could become available. Further, the data may be disseminated to one or multiple leanable vehicle and driver sets as required, for example, the first leanable vehicle and the second leanable vehicle. One advantage of such a method is that more powerful computing systems can be used without having to worry about increased weight or weight distribution on individual leanable vehicles with such systems.

As discussed above, the cloud based data can reside on the server (561) and be accessible to any number of devices, including other leanable vehicles such as those illustrated in FIG. 5. This distribution of the data allows for information such as changing weather conditions, road hazards, or traffic flow patterns to be shared between the other devices and used by the other devices to aid in the calculation of the necessary behavior for their optimal performance.

In some embodiments, the server (561) does not need to be continuously online. The server can remain offline until it is necessary to send commands or instructions.

In some embodiments, the data does not need to come from a leanable vehicle. A driver (120) can enter information such as a desired aggressiveness, current track conditions, driver profile information or other data through an app on a mobile device (530) or other interface (e.g., a laptop or tablet computer, a user interface of a leanable vehicle) that would be taken into account.

In an embodiment, the server computing system can include a server engine, a web page management component, a content management component, and a database management component. The server engine can perform basic processing and operating-system level tasks. The web page management component can handle creation and display, or routing of web pages or screens associated with receiving and providing digital content and digital advertisements. Users (e.g., cloud users) can access one or more of the server computing systems by means of a Uniform Resource Locator (“URL”) associated therewith. The content management component can handle most of the functions in the embodiments described herein. The database management component can include storage and retrieval tasks with respect to the database, queries to the database, and storage of data.

In some embodiments, a server computing system can be configured to display information in a window, a web page, or the like. An application including any program modules, applications, services, processes, and other similar software executable when executed on, for example, the server computing system, can cause the server computing system to display windows and user interface screens in a portion of a display screen space. With respect to a web page, for example, a user via a browser on the client computing system can interact with the web page, and then supply input to the query/fields and/or service presented by the user interface screens. The web page can be served by a web server, for example, the server computing system, on any Hypertext Markup Language (“HTML”) or Wireless Access Protocol (“WAP”) enabled client computing system or any equivalent thereof. The client computing system can host a browser and/or a specific application to interact with the server computing system. Each application has a code scripted to perform the functions that the software component is coded to carry out such as presenting fields to take details of desired information. Algorithms, routines, and engines within, for example, the server computing system can take the information from the presenting fields and put that information into an appropriate storage medium such as a database (e.g., database). A comparison wizard can be scripted to refer to a database and make use of such data. The applications may be hosted on, for example, the server computing system and served to the specific application or browser of, for example, the client computing system. The applications then serve windows or pages that allow entry of details.

### Computing Systems

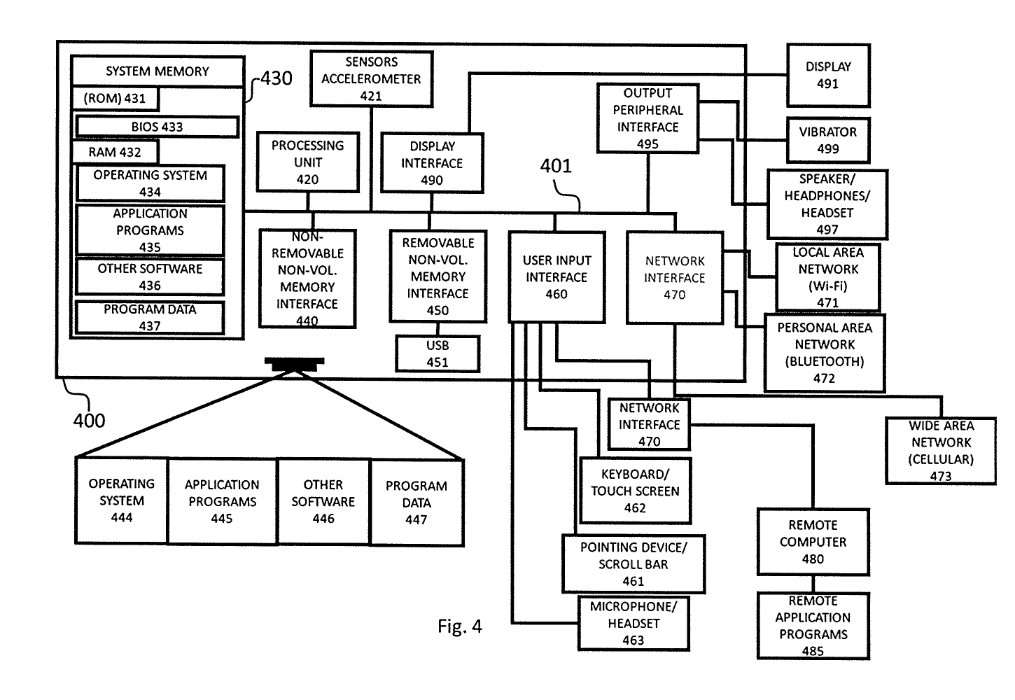

FIG. 4 illustrates a computing system that can be implemented with some embodiments of the system for enhancing driving performance of the leanable vehicle. For example, the computing system shown in FIG. 4 can be used to carry out the processes described herein on the leanable vehicle, on a robot (acting as a driver), and/or or on one or more of the devices shown in FIG. 5, such as the mobile device (530), tablet device (520) or laptop (580). A computing system can be, wholly or partially, part of one or more of the server or client computing devices in accordance with some embodiments. The computing systems may be specifically configured and adapted to carry out the processes discussed herein. Components of the computing system can include, but are not limited to, a processing unit (420) having one or more processing cores, a system memory (430), and a system bus (401) that couple various system components including the system memory to the processing unit. The system bus may be any of several types of bus structures selected from a memory bus or memory controller, a peripheral bus, and a local bus using any of a variety of bus architectures.

The computing system typically includes a variety of computing machine-readable media. Computing machine-readable media can be any available media that can be accessed by computing system and includes both volatile and nonvolatile media, and removable and non-removable media. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by a computing device. Transitory media such as wireless channels are not included in the machine-readable media. Communication media typically embody computer readable instructions, data structures, other executable software, or other transport mechanism and includes any information delivery media.

The system memory includes computer storage media in the form of volatile and/or nonvolatile memory such as read only memory (431) (ROM) and random-access memory (432) (RAM). A basic input/output system (433) (BIOS) containing the basic routines that help to transfer information between elements within the computing system, such as during start-up, is typically stored in ROM. RAM typically contains data and/or software that are immediately accessible to and/or presently being operated on by the processing unit. By way of example, and not limitation, the RAM can include a portion of the operating system, application programs, other executable software, and program data.

The drives and their associated computer storage media discussed above, provide storage of computer readable instructions, data structures, other executable software and other data for the computing system.

A user may enter commands and information into the computing system through input devices such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus, but can be connected by other interface and bus structures, such as a parallel port, game port, or a universal serial bus (USB). A display monitor or other type of display screen device is also connected to the system bus via an interface, such as a display interface. In addition to the monitor, computing devices may also include other peripheral output devices such as speakers, a vibrator, lights, and other output devices, which may be connected through an output peripheral interface.

The computing system can operate in a networked environment using logical connections to one or more remote computers/client devices, such as a remote computing system. The logical connections can include a personal area network (“PAN”) (e.g., Bluetooth®), a local area network (“LAN”) (e.g., Wi-Fi), and a wide area network (“WAN”) (e.g., cellular network), but may also include other networks. Such networking environments are commonplace in offices, enterprise-wide computer networks, intranets and the Internet. A browser application may be resident on the computing device and stored in the memory.

It should be noted that the present design can be carried out on a computing system. However, the present design can be carried out on a server, a computing device devoted to message handling, or on a distributed system in which different portions of the present design are carried out on different parts of the distributed computing system.

Another device that may be coupled to a bus is a power supply such as a DC power supply (e.g., battery) or an AC adapter circuit. As discussed above, the DC power supply may be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

### III. EXAMPLE METHODS

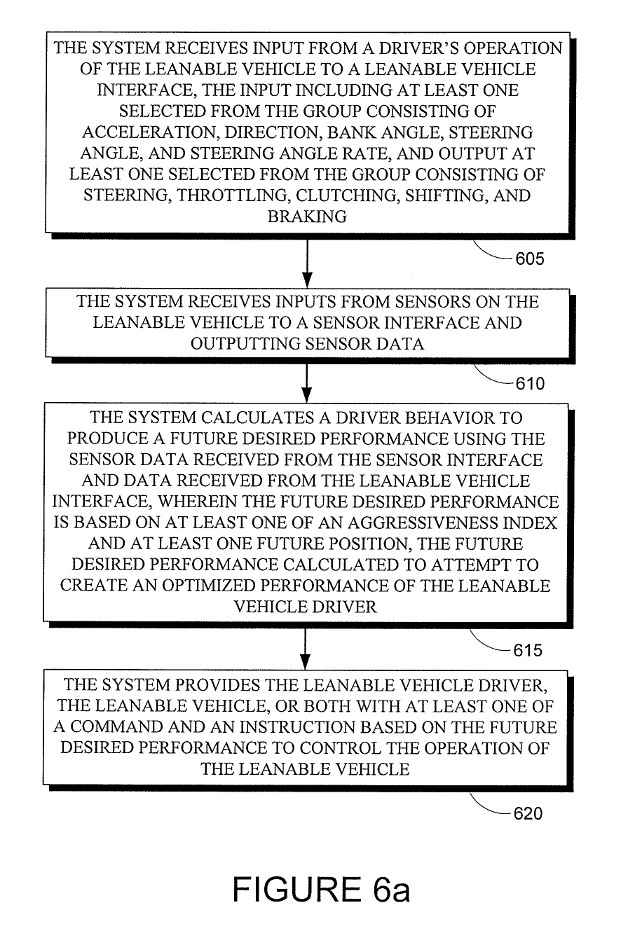

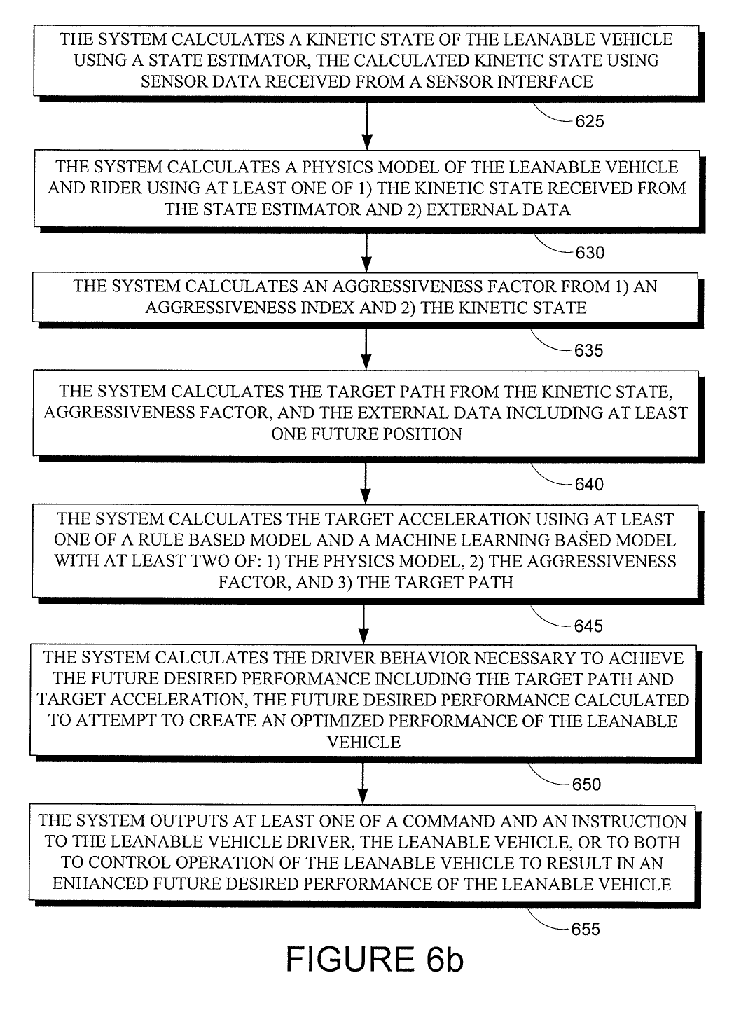

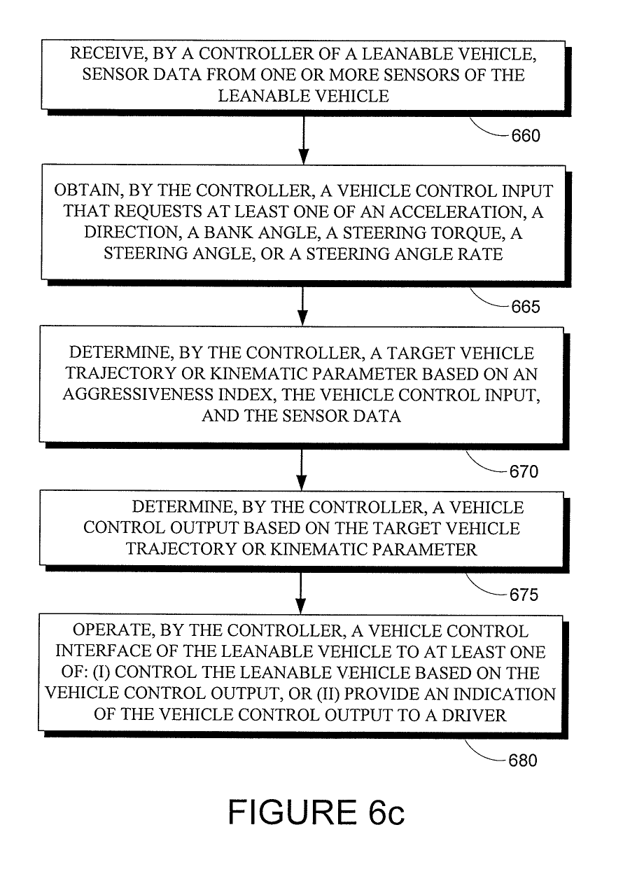

FIGS. 6a and 6b illustrate flow diagrams of an embodiment of a system to enhance the driving performance of a leanable vehicle. The following steps may be performed in any order where logically possible.

In step 605 of FIG. 6a, the system receives input from a driver's operation of the leanable vehicle to a leanable vehicle interface, the input including at least one selected from the group consisting of acceleration, direction, bank angle, steering angle and steering angle rate, and output at least one selected from the group consisting of steering, throttling, clutching, shifting and braking. In step 610, the system receives inputs from sensors on the leanable vehicle to a sensor interface and outputting sensor data. In step 615, the system calculates a driver behavior to produce a future desired performance using the sensor data received from the sensor interface and data received from the leanable vehicle interface, wherein the future desired performance is based on at least one of an aggressiveness index and at least one future position, the future desired performance calculated to attempt to create an optimized performance of the leanable vehicle driver. In step 620, the system provides the leanable vehicle driver, the leanable vehicle or both with at least one of a command and an instruction based on the future desired performance to control the operation of the leanable vehicle.

In FIG. 6b, in step 625, the system calculates a kinetic state of the leanable vehicle using a state estimator, the calculated kinetic state using sensor data received from a sensor interface. In step 630, The system calculates a physics model of the leanable vehicle and driver using at least one of 1) the kinetic state received from the state estimator and 2) external data. In step 635, the system calculates an aggressiveness factor from 1) an aggressiveness index and 2) the kinetic state. In step 640, the system calculates the target path from the kinetic state, aggressiveness factor and the external data including at least one future position. In step 645, the system calculates the target acceleration using at least one of a rule based model and machine learning based model with at least two of: 1) the physics model, 2) aggressiveness factor and 3) target path. In step 650, the system calculates the driver behavior necessary to achieve the future desired performance including the target path and target acceleration, the future desired performance calculated to attempt to create an optimized performance of the leanable vehicle. In step 655, the system outputs at least one of a command and an instruction to the leanable vehicle driver, the leanable vehicle or to both to control operation of the leanable vehicle to result in an enhanced future desired performance of the leanable vehicle.

FIG. 6c is a flowchart of a method to enhance a driving performance of a leanable vehicle. The method includes receiving, by a controller of the leanable vehicle, sensor data from one or more sensors of the leanable vehicle (660). The received sensor data is indicative of a state of the leanable vehicle. The method also includes obtaining, by the controller, a vehicle control input (665). The obtained vehicle control input requests at least one of an acceleration, a direction, a bank angle, a steering torque, a steering angle, or a steering angle rate. The method also includes determining, by the controller, a target vehicle trajectory or kinematic parameter based on an aggressiveness index, the vehicle control input, and the sensor data (670). The method also includes determining, by the controller, a vehicle control output based on the target vehicle trajectory or kinematic parameter (675). The determined vehicle control output specifies at least one of a steering operation, a throttle operation, a clutch operation, a shifting operation, or a braking operation. The method additionally includes operating, by the controller, a vehicle control interface of the leanable vehicle to at least one of: (i) control the leanable vehicle based on the vehicle control output, or (ii) provide an indication of the vehicle control output to a driver (680).

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

### IV. ENUMERATED EXAMPLE EMBODIMENTS

Embodiments of the present disclosure may thus relate to one of the enumerated example embodiments (EEEs) listed below.

EEE 1 is a system to enhance a driving performance of a leanable vehicle comprising:
a leanable vehicle interface to receive input from a driver's operation of the leanable vehicle including at least one selected from the group consisting of acceleration, direction, bank angle, steering angle and steering angle rate, and to output at least one selected from the group consisting of steering, throttling, clutching, shifting and braking;
a sensor interface to receive inputs from sensors on the leanable vehicle and output sensor data;
a computing module, to receive sensor data from the sensor interface and data from the leanable vehicle interface, the computing module to use the data from both the sensor interface and the leanable vehicle operating interface to calculate a driver behavior to produce a future desired performance, wherein the future desired performance is based on at least one of an aggressiveness index and at least one future position, the future desired performance calculated to attempt to create an optimized performance of the leanable vehicle; and a data output to receive the future desired performance in order to provide at least one of a command and an instruction to the driver or the leanable vehicle interface to control the operation of the leanable vehicle.

EEE 2 is the system of EEE1, wherein the future desired performance includes at least one of a target path and a target acceleration.

EEE 3 is the system of EEE1, wherein the computing module is located on the leanable vehicle.

EEE 4 is the system of EEE 2, wherein the computing module comprises:
a state estimator to receive the sensor data from the sensor interface to calculate a kinetic state of the leanable vehicle;
a dynamic leanable vehicle model module to receive at least one of 1) the kinetic state from the state estimator and 2) external data, the dynamic leanable vehicle model module to use either the kinetic state, external data or both to calculate a physics model of the leanable vehicle and leanable vehicle rider;
an aggressiveness engine to receive 1) the aggressiveness index and 2) the kinetic state, to calculate an aggressiveness factor;
a path follower module to receive the kinetic state from the state estimator, the calculated aggressiveness factor from the aggressiveness engine and the external data including at least one future position, in order to calculate the target path; and
a model based controller to receive and use at least two of: 1) the calculated physics model, 2) calculated aggressiveness factor and 3) calculated target path, along with at least one of a rule based model and machine learning based model to determine the target acceleration;
wherein the data output is configured to receive the calculated target path and determined target acceleration and configured to output the command or instruction to the leanable vehicle driver, the leanable vehicle interface or both to control the leanable vehicle in order to achieve the future desired performance.

EEE 5 is the system of EEE1, wherein the aggressiveness index is a measure of a level of performance selected by the driver of the leanable vehicle.

EEE 6 is the system of EEE1, wherein the sensors include at least one selected from the group consisting of: a speed sensor, an inertial sensor, a steering angle sensor, a bank angle sensor, a tire slippage sensor, a tire wear sensor, a tire pressure sensor, a throttle position sensor, a cam position sensor, a gear selection sensor, a bank angle sensor, an oxygen sensor, a weight sensor, an oil pressure sensor, and an oil purity sensor.

EEE 7 is the system of EEE 2, wherein the external data includes at least one of weather data, road condition data, road hazard data, road camber, and road slope.

EEE 8 is the system of EEE 2, further comprising past performance data that is used by at least one of the model based controller, state estimator and dynamic model in order to enhance a future desired performance.

EEE 9 is the system of EEE 7, wherein the external data is located in the cloud.

EEE 10 is the system of EEE9, wherein the external data is data aggregated from at least one other leanable vehicle.

EEE 11 is the system of EEE 2, wherein the model based controller uses a rule based model.

EEE 12 is the system of EEE 2, wherein the model based controller uses a machine learning based model.

EEE 13 is the system of EEE 2, wherein the physics model include at least one selected from the group consisting of: a center of gravity, a wheelbase, a caster angle, a tire width, a wheel inertia, and a leanable vehicle inertia.

EEE 14 is a method to enhance a driving performance of a leanable vehicle comprising:
receiving input from a driver's operation of the leanable vehicle to a leanable vehicle interface, the input including at least one selected from the group consisting of acceleration, direction, bank angle, steering angle and steering angle rate, and output at least one selected from the group consisting of steering, throttling, clutching, shifting and braking;
receiving input from sensors on the leanable vehicle to a sensor interface and outputting sensor data;
calculating a driver behavior to produce a future desired performance using the sensor data received from the sensor interface and data received from the leanable vehicle interface, wherein the future desired performance is based on at least one of an aggressiveness index and at least one future position, the future desired performance calculated to attempt to create an optimized performance of the leanable vehicle driver; and
providing the leanable vehicle driver, the leanable vehicle or both with at least one of a command and an instruction based on the future desired performance to control the operation of the leanable vehicle.

EEE 15 is the method of EEE 14, wherein the future desired performance includes at least one of a target path and a target acceleration.

EEE 16 is the method of EEE 15, further comprising:
calculating a kinetic state of the leanable vehicle using a state estimator, the calculated kinetic state using sensor data received from a sensor interface;
calculating a physics model of the leanable vehicle and rider using at least one of 1) the kinetic state received from the state estimator and 2) external data;
aggressiveness index calculating an aggressiveness factor from 1) an aggressiveness index and 2) the kinetic state;
calculating the target path from the kinetic state, aggressiveness factor and the external data including at least one future position;
calculating the target acceleration using at least one of a rule based model and machine learning based model with at least two of: 1) the physics model, 2) aggressiveness factor and 3) target path; and
   calculating the driver behavior necessary to achieve the future desired performance including the target path and target acceleration, the future desired performance calculated to attempt to create an optimized performance of the leanable vehicle; and
   outputting at least one of a command and an instruction to the leanable vehicle driver, the leanable vehicle or to both to control operation of the leanable vehicle to result in an enhanced future desired performance of the leanable vehicle.

EEE 17 is the method of EEE 14, wherein the aggressiveness index is a measure of a level of performance selected by the driver of leanable vehicle.

EEE 18 is the method of EEE 14, wherein the sensors include at least one of a speed sensor, an inertial sensor, a steering angle sensor, a bank angle sensor, a tire slippage sensor, a tire wear sensor, a tire pressure sensor, a throttle position sensor, a cam position sensor, a gear selection sensor, a bank angle sensor, an oxygen sensor, a weight sensor, an oil pressure sensor, and an oil purity sensor.

EEE 19 is the method of EEE 15, wherein the external data includes at least one of weather data, road condition data, road hazard data, road camber, and road slope.

EEE 20 is the method of EEE 15, further comprising using a past performance data in order to enhance a future desired performance.

EEE 21 is the method of EEE 15, further comprising receiving the external data from the cloud.

EEE 22 is the method of EEE 15, further comprising receiving the external data from another leanable vehicle.

EEE 23 is the method of EEE 15, wherein calculating the target acceleration comprises using a rule based model.

EEE 24 is the method of EEE 15, wherein calculating the target acceleration comprises using a machine learning based model.

EEE 25 is the method of EEE 15, wherein the physics model includes at least one of a center of gravity, wheelbase, caster angle, tire width, wheel inertia, leanable vehicle inertia.

EEE 26 is a non-transitory machine-readable medium configured to store instructions and data that when executed by one or more processors on an electronic device, causes the electronic device to perform the following operations, comprising:
receiving input from a driver's operation of the leanable vehicle to a leanable vehicle interface, the input including at least one selected from the group consisting of acceleration, direction, bank angle, steering angle and steering angle rate, and output at least one selected from the group consisting of steering, throttling, clutching, shifting and braking;
receiving input from sensors on the leanable vehicle to a sensor interface and outputting sensor data;
calculating a driver behavior to produce a future desired performance using the sensor data received from the sensor interface and data received from the leanable vehicle interface wherein the future desired performance is based on at least one of an aggressiveness index and at least one future position, the future desired performance calculated to attempt to create an optimized performance of the leanable vehicle driver; and
providing the leanable vehicle driver with at least one of a command and an instruction based on the future desired performance to control the operation of the leanable vehicle.

### V. CONCLUSION

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A system for enhancing a driving performance of a leanable vehicle comprising:
one or more sensors configured to be disposed on the leanable vehicle;
a vehicle control interface configured to be disposed on the leanable vehicle; and
a controller, wherein the controller comprises one or more processors configured to perform controller operations comprising:
receiving sensor data from the one or more sensors, wherein the sensor data is indicative of a state of the leanable vehicle;
obtaining a vehicle control input, wherein the vehicle control input requests at least one of an acceleration, a direction, a bank angle, a steering torque, a steering angle, or a steering angle rate;
determining a target vehicle trajectory or kinematic parameter based on an aggressiveness index, the vehicle control input, and the sensor data;
determining a vehicle control output based on the target vehicle trajectory or kinematic parameter, wherein the vehicle control output specifies at least one of a steering operation, a throttle operation, a clutch operation, a shifting operation, or a braking operation; and
operating the vehicle control interface of the leanable vehicle to at least one of: (i) control the leanable vehicle based on the vehicle control output, or (ii) provide an indication of the vehicle control output to a driver.

2. The system of claim 1, wherein the driver is a robotic driver.

3. The system of claim 1, wherein the target vehicle trajectory or kinematic parameter comprises a target bank angle, wherein the sensor data comprises information indicative of a bank angle of the leanable vehicle, wherein determining the vehicle control output comprises:
determining, by the controller, a difference between the target bank angle and the bank angle of the leanable vehicle indicated by the sensor data;
determining, by the controller, a steering torque level based on the determined difference; and
determining, by the controller, a steering operation to apply the determined steering torque level, wherein the vehicle control output specifies at least the determined steering operation.

4. The system of claim 1, wherein the target vehicle trajectory or kinematic parameter comprises a target longitudinal acceleration, wherein the sensor data comprises information indicative of a rotation speed of an engine of the leanable vehicle, and wherein determining the vehicle control output comprises:
determining, by the controller, a difference between the target longitudinal acceleration and the longitudinal acceleration of the leanable vehicle indicated by the sensor data; and
determining, by the controller, a target throttle position based on the rotation speed of the engine indicated by the sensor data and the determined difference between the target longitudinal acceleration and the longitudinal acceleration of the leanable vehicle; and
determining, by the controller, a throttle operation based on the target throttle position.

5. The system of claim 1, wherein the target vehicle trajectory or kinematic parameter comprises a target acceleration, and wherein determining the target vehicle trajectory or kinematic parameter based on the aggressiveness index, the vehicle control input, and the sensor data comprises:
determining, by the controller, a maximum acceleration based on the aggressiveness index; and
determining, by the controller, the target vehicle trajectory or kinematic parameter such that the target acceleration does not exceed the maximum acceleration.

6. The system of claim 5, wherein the controller operations further comprise:
determining, by the controller, that a distance between the leanable vehicle and a particular location is less than a threshold distance, wherein determining the maximum acceleration based on the aggressiveness index comprises determining the maximum acceleration based on the aggressiveness index and the distance between the leanable vehicle and the particular location being less than the threshold distance.

7. The system of claim 1, wherein the controller is configured to be disposed on the leanable vehicle.

8. The system of claim 1, wherein the one or more sensors of the leanable vehicle include at least one of a camera, a speed sensor, an inertial sensor, a steering angle sensor, a bank angle sensor, a tire slippage sensor, a tire wear sensor, a tire pressure sensor, a throttle position sensor, a cam position sensor, a gear selection sensor, a bank angle sensor, an oxygen sensor, a weight sensor, an oil pressure sensor, or an oil purity sensor.

9. A method to enhance a driving performance of a leanable vehicle comprising:
receiving, by a controller of the leanable vehicle, sensor data from one or more sensors of the leanable vehicle, wherein the sensor data is indicative of a state of the leanable vehicle;
obtaining, by the controller, a vehicle control input, wherein the vehicle control input requests at least one of an acceleration, a direction, a bank angle, a steering torque, a steering angle, or a steering angle rate;
determining, by the controller, a target vehicle trajectory or kinematic parameter based on an aggressiveness index, the vehicle control input, and the sensor data;
determining, by the controller, a vehicle control output based on the target vehicle trajectory or kinematic parameter, wherein the vehicle control output specifies at least one of a steering operation, a throttle operation, a clutch operation, a shifting operation, or a braking operation; and
operating, by the controller, a vehicle control interface of the leanable vehicle to at least one of: (i) control the leanable vehicle based on the vehicle control output, or (ii) provide an indication of the vehicle control output to a driver.

10. The method of claim 9, wherein the target vehicle trajectory or kinematic parameter includes a turn, and wherein determining the target vehicle trajectory or kinematic parameter based on the aggressiveness index, the vehicle control input, and the sensor data comprises:
determining a maximum acceleration based on the aggressiveness index; and
determining the target vehicle trajectory or kinematic parameter such that an acceleration of the leanable vehicle at an apex of the turn does not exceed the maximum acceleration.

11. The method of claim 9, wherein the target vehicle trajectory or kinematic parameter includes a target vehicle trajectory that has a turn, wherein the turn has an apex, wherein the target vehicle trajectory or kinematic parameter additionally includes a target velocity corresponding to the apex, and wherein determining the target vehicle trajectory or kinematic parameter based on the aggressiveness index, the vehicle control input, and the sensor data comprises:
determining a pre-apex point on the target vehicle trajectory, wherein the pre-apex point is located on the target vehicle trajectory before the apex by a distance that is based on the aggressiveness index;
determining, for a plurality of points on the target vehicle trajectory before the pre-apex point, respective maximum accelerations;
determining, based on the target vehicle trajectory, the target velocity, and the determined maximum accelerations, a braking commencement point on the target vehicle trajectory that is sufficiently before the pre-apex point such that, if braking is applied beginning at the braking commencement point, the velocity of the leanable vehicle can be reduced from a starting velocity at the braking commencement point to the target velocity at the pre-apex point while maintaining the acceleration of the vehicle, at the points on the target vehicle trajectory between the braking commencement point and the pre-apex point, at or below the determined respective maximum accelerations for the points on the target vehicle trajectory between the braking commencement point and the pre-apex point.

12. The method of claim 9, wherein determining the target vehicle trajectory or kinematic parameter additionally comprises determining the target vehicle trajectory or kinematic parameter based on external data about the environment of the leanable vehicle.

13. The method of claim 12, wherein the external data comprises at least one of weather data, road condition data, road traction data, road hazard data, road camber, or road slope.

14. The method of claim 12, wherein the external data comprises data about a particular location, and wherein the method further comprises:
determining, by the controller, that a distance between the leanable vehicle and the particular location is less than a threshold distance, wherein determining the target vehicle trajectory or kinematic parameter based on external data about the environment of the leanable vehicle comprises, responsive to determining that the distance between the leanable vehicle and the particular location is less than the threshold distance, determining the target vehicle trajectory or kinematic parameter based on the data about the particular location.

15. The method of claim 12, further comprising:
receiving, from another leanable vehicle, the external data.

16. The method of claim 12, further comprising:
receiving, from a remote server, the external data.

17. The method of claim 12, wherein the target vehicle trajectory or kinematic parameter comprises a target vehicle trajectory and a target acceleration, and wherein the method further comprises:
applying a state estimator to the received sensor data to determine a kinetic state of the leanable vehicle;
applying a model generator to generate, based on at least one of the determined kinetic state or the external data, a physics model of the leanable vehicle and the driver;
generating, based on the determined kinetic state, the external data, and the aggressiveness index, the target vehicle trajectory;
applying a model-based controller to at least two of: 1) the generated physics model, 2) the aggressiveness index, or 3) the generated target vehicle trajectory to determine the target acceleration, wherein determining, by the controller, the vehicle control output based on the target vehicle trajectory or kinematic parameter comprises determining the vehicle control output based on the target vehicle trajectory or the target vehicle acceleration.

18. The method of claim 17, wherein the model-based controller includes a rule-based model.

19. The method of claim 17, wherein the model-based controller includes a machine learning-based model.

20. The method of claim 17, wherein generating a physics model of the leanable vehicle and the driver comprises generating a physics model that includes a representation of at least one of a center of gravity, a wheelbase, a caster angle, a tire width, a wheel inertia, and a leanable vehicle inertia.

21. The method of claim 17, further comprising:
obtaining information about past performance of the leanable vehicle; and
prior to at least one of: 1) applying the state estimator to determine the kinetic state of the leanable vehicle, 2) applying the model generator to generate the physics model of the leanable vehicle and the driver, or 3) applying the model-based controller to determine the target acceleration, using the obtained information about past performance of the leanable vehicle to update at least one of the state estimator, the model generator, or the model-based controller models.
